(19) United States
(12) Patent Application Publication
(10) Pub. No.: US 2010/0183870 A1
(43) Pub. Date: Jul. 22, 2010

(54) RESIN COMPOSITION FOR HYBRID OPTICAL ELEMENT, AND HYBRID OPTICAL ELEMENT

(75) Inventor: Nobuyuki KOBAYASHI, Hyogo (JP)

Correspondence Address: HAMRE, SCHUMANN, MUELLER & LARSON P.C., P.O. BOX 2902, MINNEAPOLIS, MN, 55402-0902, US

(73) Assignee: PANASONIC CORPORATION, Osaka (JP)

(21) Appl. No.: 12/689,615

(22) Filed: Jan. 19, 2010

(30) Foreign Application Priority Data
Jan. 21, 2009 (JP) 2009-011307

(51) Int. Cl. B32B 27/00; C08F 2/46

(52) U.S. Cl. 428/335; 522/67; 524/81; 428/334

(57) ABSTRACT

The present invention provides a resin composition for a hybrid optical element including a curable compound, an organosilane compound, and a fluorine compound. The present invention also provides a hybrid optical element including an optical substrate and a resin layer, wherein the resin layer is a cured product of the above resin composition for a hybrid optical element.

### BACKGROUND OF THE INVENTION

1. Field of the Invention

The present invention relates to a hybrid optical element including an optical substrate and a resin layer, and to a resin composition to be used for forming the resin layer.

2. Description of Related Art

Optical materials in which a resin layer is joined to an optical substrate such as glass are called hybrid optical elements, and they exhibit better properties than their optical substrates alone. Therefore, for example, hybrid lenses in which a layer of a photo-curable resin is stacked on a lens made of glass or the like are used recently as lenses for a camera, lenses for a projector, lenses for an optical disk, and the like (e.g., see JP 2006-251017 A).

FIG. 3 shows a typical production process for a hybrid lens. First, as shown in FIG. 3(a), a resin composition 33 is dropped from a dispenser 32 onto a surface of a mold 31 that has a shape corresponding to a shape of a resin layer of a hybrid lens. Next, as shown in FIG. 3(b), a lens substrate (optical substrate) 12′ is put thereon so that the resin composition 33 is spread. Thereafter, as shown in FIG. 3(c), an ultraviolet ray 34 is irradiated thereto with the lens substrate being set at the predetermined height, so that the resin composition is cured to form an optical layer. A product is released from the mold and thus, a hybrid lens 11′ in which the optical layer made of a resin is formed on the lens substrate is obtained (FIG. 3(d)).

In this conventional production process for a hybrid lens, there has been a problem that the adhesion between the resin layer and the lens substrate is poor and thus, the resin layer easily separates from the lens substrate. In addition, the adhesion between the mold and the resin is relatively high, and therefore, there has been a problem that the resin layer is not released easily from the mold. These problems reduce the yield and productivity of the hybrid optical element.

### SUMMARY OF THE INVENTION

It is an object of the present invention to provide a resin composition for a hybrid optical element that allows separation between a resin layer and an optical substrate to hardly occur and separation between a mold and a resin layer to easily occur in a production of a hybrid optical element. It is another object of the present invention to provide a hybrid optical element with high yield and excellent productivity.

The present invention is a resin composition for a hybrid optical element including a curable compound, an organosilane compound, and a fluorine compound.

The present invention also is a hybrid optical element including an optical substrate and a resin layer, wherein the resin layer is a cured product of the above resin composition for a hybrid optical element.

When a hybrid optical element is produced using the resin composition for a hybrid optical element of the present invention, separation between a resin layer and an optical substrate hardly occurs and separation between a mold and a resin layer easily occurs. Therefore, when a hybrid optical element is produced using the resin composition, the yield is high and the productivity is excellent.

### BRIEF DESCRIPTION OF THE DRAWINGS

FIG. 1 is a sectional view of one embodiment of the hybrid optical element of the present invention.

FIG. 2 is a sectional view of another embodiment of the hybrid optical element of the present invention.

FIG. 3 is a sectional view showing an outline of a production process for a hybrid optical element (hybrid lens).

### DETAILED DESCRIPTION OF THE INVENTION

The resin composition for a hybrid optical element of the present invention includes, as essential components, (A) a curable compound, (B) an organosilane compound, and (C) a fluorine compound.

(A) The curable compound is a component that allows the resin composition to be cured. The kind of the curable compound is not particularly limited as long as the curable compound exhibits desired optical properties and curabilty. Known curable compounds used in a production of a hybrid optical element may be used. For example, a (meth)acrylate compound, an epoxy compound, a polyol compound/a polyisocyanate compound, a polythiol compound/a polyisocyanate compound, and the like may be used, and a (meth)acrylate compound and an epoxy compound preferably are used since these make photo-curing easy.

As the (meth)acrylate compound, one that is used commonly in optics applications can be used, and examples thereof include monofunctional (meth)acrylates such as methyl (meth)acrylate, ethyl (meth)acrylate, cyclohexyl (meth)acrylate, dicyclopentyl (meth)acrylate, isobornyl (meth)acrylate, bornyl (meth)acrylate, phenyl (meth)acrylate, halogen-substituted phenyl (meth)acrylate, benzyl (meth)acrylate, α-naphthyl (meth)acrylate, β-naphthyl (meth)acrylate, and dicyclopentyloxyethyl acrylate; and multifunctional (meth)acrylates such as ethylene glycol dimethacrylate, triethylene glycol di(meth)acrylate, polyethylene glycol di(meth)acrylate, neopentyl glycol di(meth)acrylate, 1,4-butanediol di(meth)acrylate, 1,6-hexanediol di(meth)acrylate, hydrogenated dicyclopentadienyl di(meth)acrylate, ethylene oxide-modified bisphenol A di(meth)acrylate, trimethylolpropane tri(meth)acrylate, pentaerythritol tetra(meth)acrylate, tetramethylolmethane tetra(meth)acrylate, pentaerythritol hexa(meth)acrylate, hexanediol diglycidyl ether di(meth)acrylate, and diethylene glycol diglycidyl ether di(meth)acrylate. In addition, epoxy acrylate, urethane acrylate and the like may be used.

As the epoxy compound, an aromatic or aliphatic epoxy compound that is used commonly in optics applications, such as a bisphenol A epoxy resin (bisphenol A diglycidyl ether), and a bisphenol F epoxy resin (bisphenol F diglycidyl ether), may be used.

(B) The organosilane compound moves selectively to a surface of an optical substrate made of an inorganic material such as glass, and has an effect to enhance adhesion between a resin layer and the optical substrate. Common silane coupling agents such as 2-(3,4-epoxycyclohexyl)ethyltrimethoxysilane, 3-glycidoxypropyltrimethoxysilane, N-2-(aminoethyl)-3-aminopropylmethyldimethoxysilane, 3-acryloxypropyltrimethoxysilane, 3-ureidopropyltrimethoxysilane, and 3-mercaptopropylmethyldimethoxysilane may be used.

(C) The fluorine compound enhances a releasing property between a resin layer and a mold, that is to say, the fluorine compound serves as a mold release agent. Examples of the fluorine compound include methyl trifluoroacetate, ethyl perfluoropropionate, ethyl perfluorooctanoate, 2,2,2-trifluoroethyl difluoromethyl ether, 1,1,2,2-tetrafluoroethyl ethyl ether, hexafluoroisopropyl methyl ether, 1H, 1H-tridecafluoroheptylamine, perfluorohexyl iodide, perfluorohexylethylene, chlorotrifluoroethylene, 3-perfluorohexyl-1,2-epoxypropane, perfluoropropionic acid, perfluoroheptanoic acid, 2-(perfluorobutyl)ethyl acrylate, 2-(perfluorohexyl) ethyl acrylate, 1H, 1H-heptafluorobutanol, 2-(perfluorobutyl)ethanol, 6-(perfluorobutyl)hexanol, and 2-(perfluorooctyl)ethanol.

The combined use of (B) the organosilane compound and (C) the fluorine compound can establish both adhesion between a resin layer and an optical substrate and a releasing property between a mold and a resin layer, and therefore, in the production of a hybrid optical element, an operation of releasing a hybrid optical element from a mold after curing a resin composition becomes very easy.

In order to promote curing of the curable compound and allow the resin composition to be photo-cured, it is preferable that the resin composition for a hybrid optical element of the present invention further contains (D) a photopolymerization initiator. As the photopolymerization initiator, a radical photopolymerization initiator and a cationic photopolymerization initiator may be used depending on the kind of the curable compound.

As the radical photopolymerization initiator, known radical photopolymerization initiators can be used, and for example, a radical photopolymerization initiator of the acetophenone type, benzoin type, benzophenone type, thioxane type, acylphosphine oxide type, or the like may be used.

As the cationic photopolymerization initiator, a cationic photopolymerization initiator that is used commonly in optics applications, such as a diaryl iodonium salt, and a triaryl sulfonium salt, may be used.

Preferable combinations of the curable compound and the photopolymerization initiator include a combination of the (meth)acrylate compound and the radical photopolymerization initiator, a combination of the epoxy compound and the cationic photopolymerization initiator, and the like. Four components, the (meth)acrylate compound, the epoxy compound, the radical photopolymerization initiator, and the cationic photopolymerization initiator, can be used in combination.

With respect to each component of the resin composition, one kind may be used, or two of more kinds may be used in combination.

With respect to the content of each component of the resin composition of the present invention, the total content of the organosilane compound and the fluorine compound is preferably 1 to 50 wt %, and more preferably 1 to 30 wt % in the resin composition. When the total content is excessively large, a refractive index difference with respect to the resin occurs and thereby the transmittance is decreased. On the other hand, when the total content is excessively small, the desired effects cannot be obtained. Furthermore, the content of the organosilane compound is preferably 10 wt % or less in the resin composition. The content of the curable compound is preferably 50 to 90 wt % in the resin composition. The content of the photopolymerization initiator is preferably 0.1 to 10 wt % with respect to the curable compound. When the content of the photopolymerization initiator falls within this range, the resin composition is allowed to be cured at the appropriate curing rate without deteriorating the properties of the resin.

A hybrid optical element such as a hybrid lens can be produced, for example, as shown in FIG. 3, by applying the resin composition of the present invention to a surface of an optical substrate and irradiating an energy ray such as a ultraviolet ray so that the resin composition is cured. In this case, separation between a resin layer and an optical substrate hardly occurs and separation between a mold and a resin layer easily occurs. Therefore, a hybrid optical element can be produced with high yield and excellent productivity.

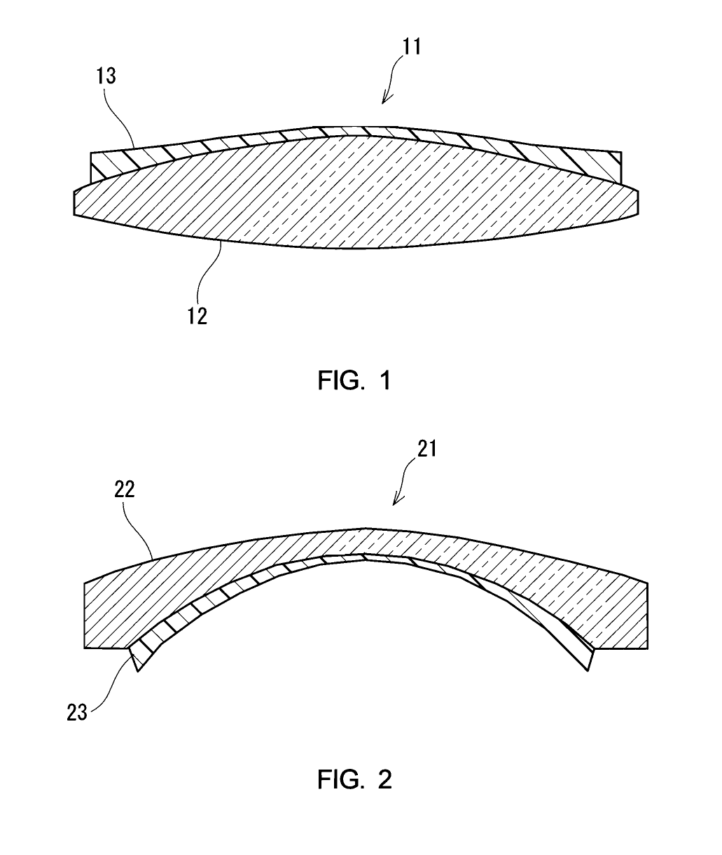

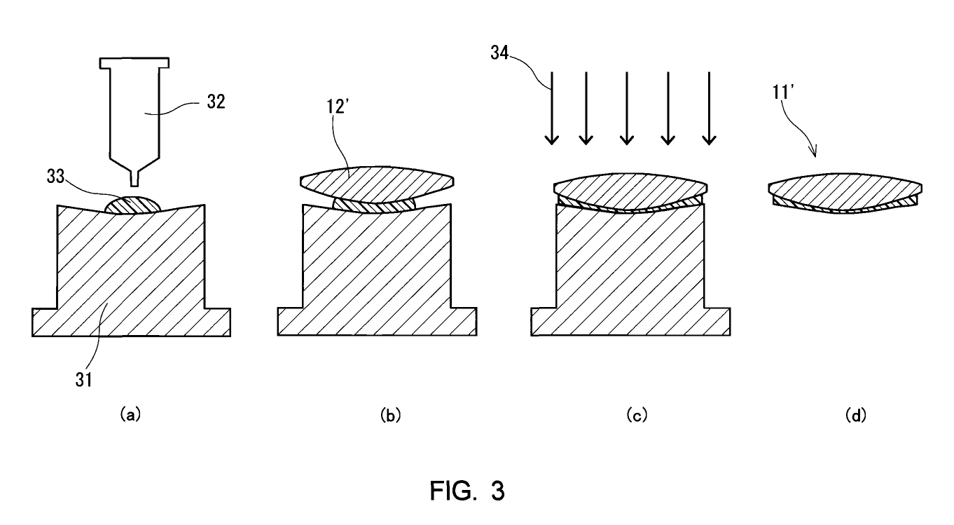

Next, the hybrid optical element of the present invention will be described. The hybrid optical element of the present invention can be constructed using the above-described resin composition according to a known method. For example, as shown in FIG. 1, the hybrid optical element (hybrid lens) 11 of the present invention includes an optical substrate (lens substrate) 12 and a resin layer 13 located on the surface of the optical substrate. The optical substrate 12 can be formed from a conventional material (e.g., glass, quartz, ceramics). The resin layer 13 is formed by curing the above-described resin composition. In FIG. 1, both of the surfaces of the optical substrate are convex. However, as shown in FIG. 2, a hybrid optical element 21 in which an optical substrate (lens substrate) 22 has one concave surface and a resin layer 23 is on the surface may be constructed. The resin layer may be formed on the both surfaces of the optical substrate.

The thickness of the resin layer is preferably 50 μm to 1 mm. When the thickness of the resin layer falls out of this range, the strength or moldability (curability) is deteriorated.

In a production of the hybrid optical element of the present invention, separation between a resin layer and an optical substrate hardly occurs and separation between a mold and a resin layer easily occurs. Therefore, the yield is high and the productivity is excellent.

### EXAMPLES

Hereinafter, an embodiment of the present invention will be described in more detail with reference to Examples and Comparative Examples. The present invention is not limited by these Examples.

### Example 1

A resin composition for a hybrid optical element was prepared by mixing the following components.

(A1) Isobornyl acrylate: 50 parts by weight
(A2) Bisphenol A epoxy resin: 30 parts by weight
(B) 3-Acryloxypropyltrimethoxysilane: 5 parts by weight
(C) Methyl trifluoroacetate: 5 parts by weight
(D1) Radical photopolymerization initiator (1-hydroxycyclohexyl phenyl ketone): 5 parts by weight
(D2) Cationic photopolymerization initiator (diphenyl-4-thiophenoxyphenylsulfonium hexafluoroantimonate): 5 parts by weight

Next, the obtained resin composition was dropped on a mold (having the same shape with the mold 31 of FIG. 3) and subjected to UV irradiation (3000 mJ/cm²) with a lens substrate being retained at the predetermined position, so that a resin layer (optical layer) was formed. Thus, a hybrid optical element was produced. Thereafter, the hybrid optical element was allowed to be released from the mold by applying a force to a member retaining the hybrid optical element, and the released state was checked. The hybrid optical element was released at the force of about 1 kN. A molded product of the resin was formed on the lens substrate, and no resin was left on the mold. In addition, the spectral transmittance (550 nm) was measured with an ultraviolet-visible-near infrared spectrometer (UV-3150 manufactured by Shimadzu Corporation) to evaluate the transparency. The spectral transmittance of the hybrid optical element was 92%, which is good.

### Example 2

A resin composition for a hybrid optical element was prepared by mixing the following components.

(A) Isobornyl acrylate: 80 parts by weight
(B) 3-Acryloxypropyltrimethoxysilane: 7 parts by weight
(C) Methyl trifluoroacetate: 7 parts by weight
(D) Radical photopolymerization initiator (1-hydroxycyclohexyl phenyl ketone): 6 parts by weight

Next, a hybrid optical element was produced in the same manner as in Example 1, and its released state was checked. The hybrid optical element was released at the force of about 0.8 kN. The molded product of the resin was formed on the lens substrate, and no resin was left on the mold. Further, the spectral transmittance measured in the same manner as in Example 1 was 92%, which is good.

### Example 3

A resin composition for a hybrid optical element was prepared by mixing the following components.

(A) Bisphenol A epoxy resin: 80 parts by weight
(B) 3-Glycidoxypropyltrimethoxysilane: 7 parts by weight
(C) Methyl trifluoroacetate 7 parts by weight
(D) Cationic photopolymerization initiator (diphenyl-4-thiophenoxyphenylsulfonium hexafluoroantimonate): 6 parts by weight Next, a hybrid optical element was produced in the same manner as in Example 1, and its released state was checked. The hybrid optical element was released at the force of about 1.2 kN. The molded product of the resin was formed on the lens substrate, and no resin was left on the mold. Further, the spectral transmittance measured in the same manner as in Example 1 was 91%, which is good.

### Example 4

A resin composition for a hybrid optical element was prepared by mixing the following components.

(A) Isobornyl acrylate: 55 parts by weight
(B) 3-Acryloxypropyltrimethoxysilane: 20 parts by weight
(C) Methyl trifluoroacetate 20 parts by weight
(D) Radical photopolymerization initiator (1-hydroxycyclohexyl phenyl ketone): 5 parts by weight

Next, a hybrid optical element was produced in the same manner as in Example 1, and its released state was checked. The hybrid optical element was released at the force of about 0.5 kN. The molded product of the resin was formed on the lens substrate, and no resin was left on the mold. Further, the spectral transmittance measured in the same manner as in Example 1 was 89%, which is good.

### Comparative Example 1

A resin composition for a hybrid optical element was prepared by mixing the following components.

(A) Ethylene glycol dimethacrylate: 95 parts by weight
(D) Radical photopolymerization initiator (1-hydroxycyclohexyl phenyl ketone): 4 parts by weight

Next, a hybrid optical element was produced in the same manner as in Example 1, and its released state was checked. The hybrid optical element was released at the force of about 1.8 kN, but more than half of the resin was left on the mold.

### Comparative Example 2

A resin composition for a hybrid optical element was prepared by mixing the following components.

(A) Bisphenol A epoxy resin: 95 parts by weight
(D) Cationic photopolymerization initiator (diphenyl-4-thiophenoxyphenylsulfonium hexafluoroantimonate): 5 parts by weight

Next, a hybrid optical element was produced in the same manner as in Example 1, and its released state was checked. The hybrid optical element was hardly released, and the molded product of the resin was broken to pieces at the force of about 4 kN.

The invention may be embodied in other forms without departing from the spirit or essential characteristics thereof. The embodiments disclosed in this specification are to be considered in all respects as illustrative and not limiting. The scope of the invention is indicated by the appended claims rather than by the foregoing description, and all changes which come within the meaning and range of equivalency of the claims are intended to be embraced therein.

### INDUSTRIAL APPLICABILITY

A hybrid optical element obtained by using the resin composition for a hybrid optical element of the present invention can be used as a lens for a camera, a lens for a projector, a lens for an optical disk, and the like.

What is claimed is:

1. A resin composition for a hybrid optical element comprising a curable compound, an organosilane compound, and a fluorine compound.

2. The resin composition for a hybrid optical element according to claim 1, further comprising a photopolymerization initiator.

3. The resin composition for a hybrid optical element according to claim 2, wherein the curable compound is a (meth)acrylate compound, and the photopolymerization initiator is a radical photopolymerization initiator.

4. The resin composition for a hybrid optical element according to claim 2, wherein the curable compound is an epoxy compound, and the photopolymerization initiator is a cationic photopolymerization initiator.

5. The resin composition for a hybrid optical element according to claim 1, wherein the total content of the organosilane compound and the fluorine compound is 1 to 50 wt %.

6. The resin composition for a hybrid optical element according to claim 5, wherein the total content of the organosilane compound and the fluorine compound is 1 to 30 wt %.

7. A hybrid optical element comprising an optical substrate and a resin layer, wherein the resin layer is a cured product of the resin composition for a hybrid optical element according to claim 1.

8. The hybrid optical element according to claim 7, wherein the thickness of the resin layer is 50 μm to 1 mm.
